(19) United States
(12) Patent Application Publication
(10) Pub. No.: US 2014/0058532 A1
(43) Pub. Date: Feb. 27, 2014

(54) METHOD FOR PARTIAL FLASHING OF ECUS

(71) Applicants: DIPANKAR DAS, AUNDH (IN); SEETHARAMAN RAJAPPAN, BANGALORE (IN); SRINATH S., BANGALORE (IN); KIRAN H. K., BANGALORE (IN)

(72) Inventors: DIPANKAR DAS, AUNDH (IN); SEETHARAMAN RAJAPPAN, BANGALORE (IN); SRINATH S., BANGALORE (IN); KIRAN H. K., BANGALORE (IN)

(73) Assignee: GM GLOBAL TECHNOLOGY OPERATIONS LLC, DETROIT, MI (US)

(21) Appl. No.: 13/593,093

(22) Filed: Aug. 23, 2012

(51) Int. Cl. G05B 19/00

(52) U.S. Cl. 700/1

(57) ABSTRACT

A system and method for compartmentalizing memory sections in a controller to allow compartments to be individually reprogrammed without affecting files in other compartments. The method includes defining a main memory in the controller that stores a plurality of different types of content files that each include lines of code, where the main memory includes compartments having memory slots for lines of code that have been programmed and empty memory slots where lines of codes can be written into. The main memory is initially programmed to store desired content files in the memory compartments. Subsequently, if it is determined that code stored in the main memory needs to be reprogrammed, the reprogramming is performed to flash only the memory compartments that include the code that needs to be reprogrammed and those memory compartments that include code that is linked to the code that needs to be reprogrammed.

### BACKGROUND OF THE INVENTION

1. Field of the Invention

This invention relates generally to a system and method for programming or flashing a controller and, more particularly, to a system and method for programming or flashing an electronic control unit (ECU) on a vehicle, where the method includes providing partial flashing of the code by defining compartments for code sections as separate memory segments including empty spaces and only flashing those compartments that need to be reprogrammed.

2. Discussion of the Related Art

Most modern vehicles include electronic control units (ECUs), or controllers, which control the operation of vehicle systems, such as the powertrain, climate control system, infotainment system, body systems, chassis systems, and others. Such controllers require special purpose-designed software in order to perform the control functions. Flashing is a well known process for uploading or programming software applications, calibration files and other content into the memory of a vehicle ECU or other programmable device. A bootloader is an embedded software program loaded on the ECU that provides an interface between the ECU and a computer device for uploading the software. The bootloader may employ asymmetric key cryptography and store a public key that must be used to decode the digital signature transferred by the computer device before uploading to or reflashing of the ECU is allowed to prevent malicious software or calibration files from being uploaded into the ECU.

After the ECU has initially been programmed on a vehicle, it may become necessary to modify or change certain parts of the code that has been uploaded, such as changing variables, adding data, making corrections to application files, etc. For example, at the end of the vehicle production line after the ECUs have been flashed, quality control may observe minor problems or errors with the code that need to be corrected, which may only require small changes to the code. Also, there may be certain security vulnerabilities in the code, which may cause buffer memory overflow for certain input conditions or the code may be susceptible to hacking. Such a security vulnerability may need to be corrected, which also may only require a small change to the code. For example, a line of code may require an “if” condition to prevent a buffer overflow. Because the various types of files in the ECU are often connected, for example, one application file may access another application file, a variable stored in a RAM of the ECU may be used in various application files in the ECU, etc., making a change at one location in the code may require changes at one or more other locations in the code.

The memory in vehicle ECUs is configured so that if a minor portion of one of the files needs to be corrected or data needs to added, that change may cause the position of other files or portions of code within the memory to be changed, which alters the entire code sequence in a cascading manner. Therefore, it is generally necessary to reflash the entire code in the memory even if only a small change to the code needs to be made. Reflashing the entire ECU memory may take a few minutes, where the actual change being made might only need a few seconds of programming time. For example, the programming tool that flashes the ECU memory is often connected to a vehicle's CAN bus to provide the programming and that CAN bus typically does not operate at high speed.

### SUMMARY OF THE INVENTION

In accordance with the teachings of the present invention, a system and method are disclosed for compartmentalizing memory sections in a controller for each of the various types of digital files, where the compartments include empty memory space for additional code to be added to allow the compartments to be individually reprogrammed without affecting other memory content. The method includes defining a main memory in the controller that stores a plurality of different types of memory content that each include lines of code, where the main memory includes compartments having memory slots for lines of code that have been programmed and empty memory slots where lines of codes can be written into. The main memory is initially programmed to store desired memory content in the memory compartments. Subsequently, if it is determined that code stored in the main memory needs to be reprogrammed, the reprogramming is performed to flash only the memory compartments that include the code that needs to be reprogrammed and those memory compartments that include code that is linked to the code that needs to be reprogrammed.

Additional features of the present invention will become apparent from the following description and appended claims, taken in conjunction with the accompanying drawings.

### BRIEF DESCRIPTION OF THE DRAWINGS

FIG. 1 is a block diagram of a method for signing and verifying electronic content using a digital signature including the delivery of content and signature files from a programming source to an executing controller;

FIG. 2 is a schematic diagram showing how electronic content and a digital signature are physically delivered to a controller in a vehicle;

FIG. 3 is a representation of a portion of a known ECU memory including memory space for various types of files;

FIG. 4 is a representation of a portion of a known ECU RAM;

FIG. 5 is a representation of a portion of an ECU memory showing memory sections for different types of files and compartments that include a particular file and additional memory space; and

FIG. 6 is a representation of an ECU RAM including several variables where the variables are defined in compartments including extra memory space.

### DETAILED DESCRIPTION OF THE EMBODIMENTS

The following discussion of the embodiments of the invention directed to a system and method for compartmentalizing memory space in an ECU to allow for partial reflashing of the ECU is merely exemplary in nature, and is in no way intended to limit the invention or its applications or uses. For example, the discussion herein is specific to a vehicle ECU. However, as will be appreciated by those skilled in the art, the system and method of the invention may have application for other types of controllers.

Vehicle ECUs need to be programmed in a secure manner to prevent malicious hacking. One known secure digital coding technique is referred to as asymmetric key cryptography that uses digital signatures for authenticating files that are programmed into controllers. As would be well understood by those skilled in the art, asymmetric key cryptography uses a pair of mathematically-related keys, known as a private key and a public key, to encrypt and decrypt a message. To create a digital signature, a signer uses his private key, which is known only to himself, to encrypt a message. The digital signature can later be decrypted by another party using the public key, which is paired to the signer's private key.

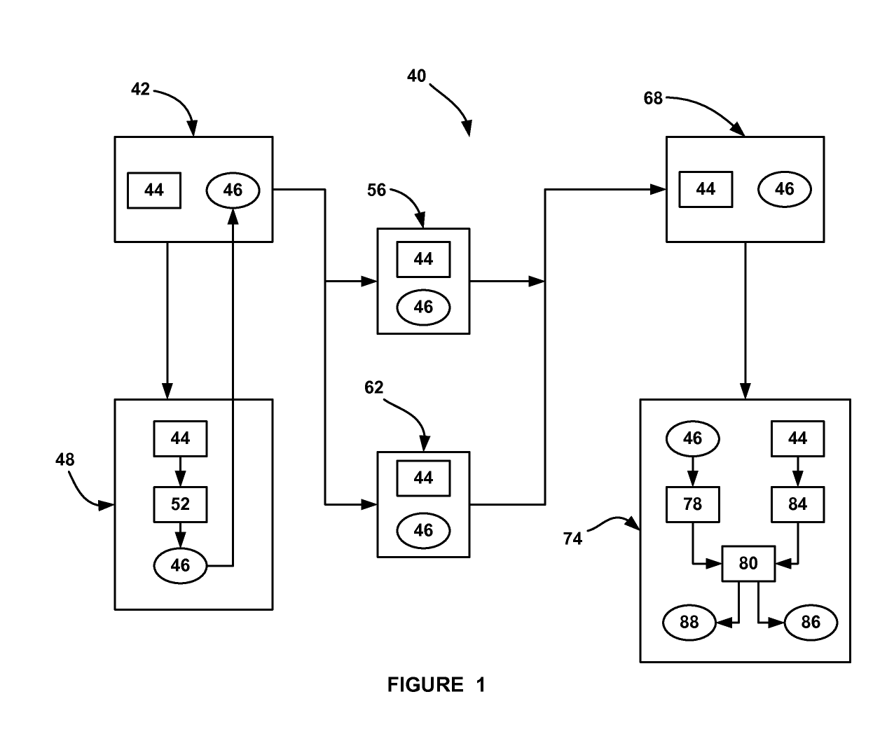

FIG. 1 is a block diagram 40 showing a method for signing and verifying digital content using a digital signature typical for programming a vehicle ECU, including the delivery of content and signature files from a programming source to an executing controller. A file repository 42 creates files, collectively referred to herein as content file 44, where the content file 44 is a binary file. It is desired to obtain a digital signature 46 for the content file 44. In order for the content file 44 to be digitally signed, the content file 44 is provided to a signing server 48. On the signing server 48, a hash calculation is performed on the content file 44 to produce a hash code 52. The hash code 52 is encrypted using the private key of the repository 42, where the encryption produces the digital signature 46. The digital signature 46 is then provided back to the repository 42.

At this point, the content file 44 and the digital signature 46 both exist in the repository 42. The challenge is then to deliver the content file 44 and the digital signature 46 through the various business systems used by the automotive manufacturer and install and validate the content file 44 on a controller in a vehicle. In general, an automotive manufacturer will have at least two organizations or departments responsible for installing software and calibration files on controllers in vehicles, namely, manufacturing and service. FIG. 1 shows a manufacturing database 56 used by the auto manufacturer's manufacturing department for managing electronic files which are installed as “parts” in production vehicles. FIG. 1 likewise shows a service database 62, used by the auto manufacturer's service department for managing electronic files which are installed as “service parts” in vehicles that are worked on in a service facility. As shown in FIG. 1, the manufacturing database 56 and the service database 62 both receive copies of the content file 44 and the digital signature 46 to be used for the respective functions of the manufacturing and service departments.

In order to actually install the content file 44 on a controller in a vehicle, a programming tool 68 is used. As shown, the programming tool 68 also receives a copy of the content file 44 and the digital signature 46. That is, the manufacturing department could provide the content file 44 and the digital signature 46 from the manufacturing database 56 to the programming tool 68 for installation on a new production vehicle, or the service department could provide the content file 44 and the digital signature 46 from the service database 62 to the programming tool 68 for installation on a vehicle being serviced.

The next step is for the programming tool 68 to install the content file 44 on a controller in a vehicle. ECU 74 is the controller that will actually use the content file 44. Following is a brief discussion of the architecture of the ECU 74. The software on the ECU 74 consists of a bootloader, a software executable, calibration files, etc. For the purposes of this discussion, the ECU 74 is assumed to have a single central processing unit (CPU). In actual vehicles, the ECU 74 could have multi-core CPUs, and each multi-core CPU would have a bootloader, a software executable, and one or more calibration files.

The bootloader in the ECU 74 is responsible for validating and installing new software executables and calibration files. Thus, the functions described in this paragraph are performed by the bootloader in the ECU 74. The programming tool 68 provides the content file 44 and the digital signature 46 to the ECU 74. The digital signature 46 is decrypted by the bootloader using the public key of the repository 42 to produce a decrypted hash code 78. Meanwhile, a hash calculation is performed on the content file 44 by the bootloader to produce a calculated hash code 84. At box 80, the decrypted hash code 78 is compared to the calculated hash code 84. If the decrypted hash code 78 matches the calculated hash code 84, then a valid determination 88 is issued, and the content file 44 is used. If the content file 44 to be used is a software executable, the bootloader installs it as the new software executable on the ECU 74. If the content file 44 to be used is a calibration file, the bootloader installs it as one of the one or more calibration files on the ECU 74. If the decrypted hash code 78 does not match the calculated hash code 84, then an invalid determination 86 is issued, and the content file 44 is not used on the ECU 74.

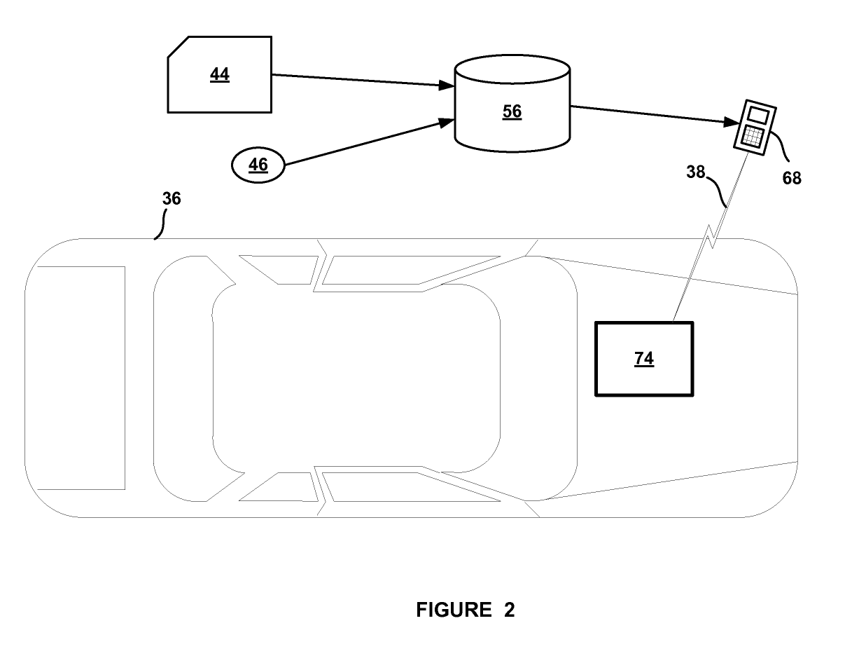

FIG. 2 is a schematic diagram showing how electronic content and digital signature files are physically delivered to a vehicle controller. A vehicle 36 includes the ECU 74 shown in FIG. 1 and discussed above. The ECU 74 could control the engine, transmission, chassis, body, infotainment, or other system on the vehicle 36. The content file 44 and the digital signature 46 are provided to a central database, shown here as the manufacturing database 56. The transfer of the content file 44 and the digital signature 46 to the manufacturing database 56 could take place over a company network. The manufacturing database 56 provides the content file 44 and the digital signature 46 to the programming tool 68, where this transfer could be accomplished by attaching the programming tool 68 to a computer which has access to the database 56. The programming tool 68 communicates with the ECU 74 via a connection 38, which may be wired or wireless. Alternately, the programming tool 68 may need to access the ECU 74 through a network of ECUs, such as through a gateway ECU. With the connection 38 established, the content file 44 and the digital signature 46 can be downloaded from the programming tool 68 to the ECU 74, where the bootloader can perform the security verification functions discussed previously.

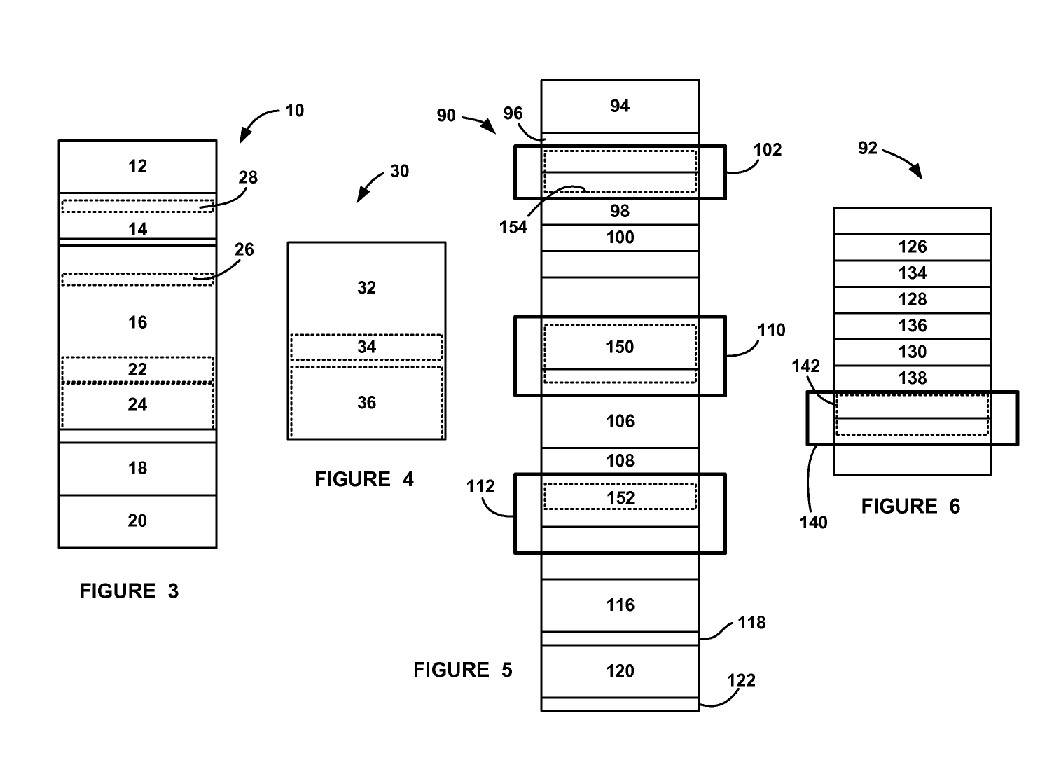

FIG. 3 is a representation of a known ECU memory 10 showing various memory slots or segments for storing different types of files that are uploaded or flashed in the memory 10, such as, for example, in the manner discussed above. When the code to be flashed is built, lines of code are first compiled, and then the lines of code are linked to each other in the various files as is necessary to operate the code. The memory 10 includes lines of code for the bootloader in memory segment 12, lines of code for RO data constants in memory segment 14, lines of application code in memory segment 16 for different and various applications, operating system (OS) code stored in memory segment 18, and calibration files stored in memory segment 20.

If the application code stored in the segment 16 needs to be corrected or changed, such as for the reasons discussed above, and lines of code need to be added and/or replaced, represented by dotted box 22, all of the lines of code in the segment 16 below the box 22 are moved down, represented by dotted box 24, which changes their address defining their location in the memory 10. For those sections of code in the memory 10 that previously accessed the lines of the code in the box 24, such as code represented by dotted box 26, that code is now unable to access the changed code because it has a different address. Further, RO data constants may need to be added to the RO data constant segment 14, for example, represented by dotted box 28, which may change the address of the constants in the memory segment 14 below the lines of code in the dotted box 28. Thus, lines of code in the application segment 16, such as those again represented by the dotted box 24, that previously needed to address the RO data constants that have changed, will now not be able to do so.

FIG. 4 is a representation of a known ECU RAM 30 including a memory segment 32 for storing certain variables that are addressed by the application segment 16, and which are stored in the RAM 30 because they may change as the operating conditions of the vehicle change. Particularly, the variables stored in the RAM 30 are those variables that change as the vehicle operates and can be, for example, pressures, temperatures, state of applications, etc. In other words, any value that changes during operation of the vehicle is stored in the RAM 30, and all other constants and values that do not change are stored in the main memory 10. If a new variable needs to be stored in the memory segment 32, such as represented by dotted box 34, then the position of those variables in the memory segment 32 below the box 34 will be changed, represented by dotted box 36. Therefore, those lines of code in the application memory segment 16, for example, also represented by the dotted box 24 that previously needed to access the variables in the dotted box 36 will not be able to do so because the addresses of those variables have now been changed. Thus, whenever a small change to the memory 10 or the RAM 30 is required, those changes have a cascading affect on other parts of the code stored in the memory 10, which requires that the entire memory 10, except the bootloader, be reflashed for these minor changes, as discussed above.

The present invention proposes a programming or differential flashing scheme for overcoming the short-comings discussed above so that individual portions of code can be reflashed in an ECU memory without having to reflash the entire code stored in the ECU memory. As will be discussed in detail below, the present invention compartmentalizes different sections of the code stored in the ECU memory, such as the RO data constants, the application code, the OS code, calibration files, etc. It is noted that the term “code” as used herein usually will refer to “read-only” data and typically not modifiable data, such as variables in RAM. Each compartment for each separate memory portion may include empty memory sections available to write additional code into so that if a particular section is expanded during the reflash, those empty sections can be used for that expansion. This includes both the constants that are stored in the main memory of the ECU and the variables that are stored in the ECU RAM. Each compartment will be assigned a specific amount of digital memory and that compartment for a particular file will be larger than is necessary for the file to be written into. Compartmentalizing the code into separate sections including extra memory space not only allows those compartments that need to be changed to be separately reflashed, but also the compartments for the other files that may be linked to that portion of the reflashed code to be reflashed.

Those sections of code in the main memory of the ECU that are linked to variables stored in the RAM will be linked to a specific compartment in the RAM so that the code for the application that accesses the variable can be selectively changed to change both the code and the variables. If variables are added to the RAM, that portion of the application file that accesses the variables would be reflashed for the new order of the variables. Alternately, dummy variables that are not used can be placed in certain sections of available memory space in the RAM that are not accessed by the application codes, but can be overwritten with a usable variable if necessary.

It is noted that the ECUs being discussed herein are single version devices having a single ID. It is also noted that when the code is reflashed and some of the empty memory sections may be filled, future reflashing can occur until all of the empty memory sections are filled. Further, the flashing tool needs to maintain a table of what sectors in the memory have been flashed by previous software versions when the flashing tool goes from one version of a particular software to another version of a particular software.

It is further noted that the discussion above concerning secure asymmetric key cryptography flashing may or may not be employed in the technique for differential flashing discussed herein. If digital signature encryption is used in the differential flashing discussed herein, then each of the separate compartments may require its own digital signature. Alternately, a single digital signature may be used for all of the compartments that may be reflashed at a particular point in time.

FIG. 5 is a representation of a main memory 90 in an ECU and FIG. 6 is a representation of a RAM 92 in the ECU. In this representation of the ECU memory 90, the bootloader is stored at memory section 94 and is followed by an empty memory section 96 where code is not initially stored to allow for additional lines of code to be stored if the bootloader 94 needs to be expanded. Following the bootloader is a series of three RO data constant files, where one of the RO data constant files is represented by memory section 98 followed by an empty memory section 100, where code is not initially stored in the memory section 100 to allow the particular RO data file to be expanded. A first combination of an RO data file and its empty memory section is defined by compartment 102. Following the RO data files are three application files, where one of the application files is represented by memory section 106 followed by an empty memory section 108 where code is not initially stored. The first application file and its empty memory section are defined by compartment 110 and the third application file and its empty memory section are defined by compartment 112. Only a portion of the empty memory section following the third application file is within the compartment 112. Following the application files is an OS code file represented by memory section 116 and including an empty memory section 118 where code is not initially stored. Following the OS code memory section are calibration files represented by memory section 120 and including empty memory section 122 for additional lines of code where code is not initially stored.

The RAM 92 includes memory sections 126, 128 and 130 identifying three variables stored in the RAM 92. Memory section 134 following section 126, memory section 136 following memory section 128 and memory section 138 following memory section 130 are all open memory space where other variables can be added between the existing variables in the RAM 92. Compartment 140 defines a combined memory section for another variable and open memory space below that variable. It is noted that a compartment in the RAM 92 may include more than one variable.

The discussion above of how the invention compartmentalizes different sections of code, where only certain compartments will typically need to be reflashed when a particular change to the code is made can be shown by example. For this example, it has been determined that it is necessary to make changes to the first application file that was initially written in the compartment 110 as identified by the lines of code in dotted box 150. The entire compartment 110 would need to be reflashed to make this modification, which in this example requires using some of the open memory space. As a result of this change to the first application file, a section of the code in the third application file represented by dotted box 152 is affected because that section of code used information that was previously stored in the first application file, which has now been changed. Therefore, the entire section of code in the compartment 112 needs to be reflashed. Further, the changes to the first application file in the dotted box 150 also required new RO constants to be added, which are stored in the first RO data file within the compartment 102 as represented by dotted box 154. Changing the constants in this file required some of the open memory space for that data file to be used within the dotted box 154. Therefore, as above, the code within the compartment 102 needs to be reflashed. Because the section of the third application file within the dotted box 152 was changed and it required using the fourth variable file in the RAM 92, then the variable in dotted box 142 needs to be changed and therefore the compartment 140 needs to be reflashed.

The illustration of the example discussed above for FIGS. 5 and 6 only shows that those particular lines of code affected by the example have been compartmentalized. However, this is shown only for purposes of clarity in that all, or almost all, of the sections of code in the memory 90 and the RAM 92 will be defined within a compartment and those specific compartments that are affected by a particular change needed to be made to the code will only be the ones affected by the reflashing.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for programming a controller, said method comprising:
defining a main memory in the controller that stores a plurality of different types of content files each including lines of code, wherein defining the main memory includes defining memory compartments within the main memory that include memory sections for lines of code that will be initially stored and open memory sections where lines of code can be written into;
defining a random access memory (RAM) within the controller that stores variables, wherein defining the RAM includes defining RAM compartments in the RAM that include one or more variables and an open memory section that variables can be written into;
programming the main memory of the controller to store desired content files in the memory compartments;
determining that code stored in the main memory needs to be reprogrammed; and
reprogramming only memory compartments within the main memory of the controller that include the code that needs to be reprogrammed and those memory compartments that include code that is linked to the code that needs to be reprogrammed.

2. The method according to claim 1 wherein reprogramming only compartments within the main memory of the controller includes adding lines of code to the open memory section in the particular compartment being reprogrammed.

3. The method according to claim 1 further comprising reprogramming RAM compartments that are affected by the code that needs to be reprogrammed.

4. The method according to claim 3 wherein reprogramming RAM compartments includes adding one or more variables to the open memory section in the RAM compartment that is reprogrammed.

5. The method according to claim 1 wherein defining a random access memory includes programming dummy variables in the open memory section that are not used by the controller.

6. The method according to claim 1 wherein determining that code stored in the main memory needs to be reprogrammed includes determining that an application file in the main memory needs to be reprogrammed.

7. The method according to claim 1 wherein determining that code stored in the main memory needs to be reprogrammed includes determining that the code needs to be reprogrammed at an end of a vehicle manufacturing process.

8. The method according to claim 1 wherein defining the main memory includes defining a memory section to include a bootloader, a plurality of memory sections to include RO data constants, a plurality of memory sections to include application files, a memory section to include operating segment code and a memory section to include calibration files.

9. The method according to claim 1 wherein the controller is an electronic control unit on a vehicle.

10. A method for reprogramming an electronic control unit (ECU) on a vehicle with software code during production of the vehicle after the ECU has initially been programmed and it is determined that one or more parts of the code need to be reprogrammed, said method comprising:
defining a main memory in the ECU that stores a plurality of different types of content files each including lines of code, wherein defining the main memory includes defining memory compartments within the main memory that include memory sections for lines of code that have been programmed and empty memory sections where lines of code can be written into; and
reprogramming only memory compartments within the main memory of the controller that include the code that needs to be reprogrammed and those memory compartments that include code linked to the code that needs to be reprogrammed.

11. The method according to claim 10 further comprising defining a random access memory (RAM) within the ECU that stores variables, wherein defining the RAM includes defining RAM compartments in the RAM that include one or more variables and an open memory section that variables can be written into, and reprogramming RAM compartments that are affected by the code that needs to be reprogrammed.

12. The method according to claim 11 wherein reprogramming RAM compartments includes adding one or more variables to the open memory section in the RAM compartment that is reprogrammed.

13. The method according to claim 11 wherein defining a random access memory includes programming dummy variables in the open memory sections that are not used by the controller.

14. A system for programming a controller, said system comprising:
means for defining a main memory in the controller that stores a plurality of different types of content files each including lines of code, said means for defining a main memory defining the main memory to include memory compartments within the main memory that includes memory sections for lines of code that will be initially stored an open memory section where lines of code can be written into;
means for defining a random access memory (RAM) within the controller that stores variables, said means for defining a random access memory defining RAM compartments in the RAM that include one or more variables and open memory section that variables can be written into;
means for programming the main memory of the controller to store desired content files in the memory compartments;
means for determining that code stored in the main memory needs to be reprogrammed; and
means for reprogramming only memory compartments within the main memory of the controller that includes the code that needs to be reprogrammed in those memory compartments that include code that is linked to the code that needs to be reprogrammed.

15. The system according to claim 14 wherein the means for reprogramming only compartments within the main memory of the controller adds lines of code to the open memory section in the particular compartment being reprogrammed.

16. The system according to claim 14 further comprising means for reprogramming RAM compartments that are affected by the code that needs to be reprogrammed.

17. The system according to claim 16 wherein the means for reprogramming RAM compartments adds one or more variables to the open memory section in the RAM compartment that is reprogrammed.

18. The system according to claim 14 wherein the means for defining a random access memory programs dummy variables in the open memory section that are not used by the controller.

19. The system according to claim 14 wherein the controller is an electronic control unit on a vehicle, and wherein the means for determining that code stored in the main memory needs to be reprogrammed determines that the code needs to be reprogrammed at an end of a vehicle manufacturing process.

20. The system according to claim 14 wherein the means for defining the main memory defines a memory section to include a bootloader, a plurality of memory sections to include RO data constants, a plurality of memory sections to include application files, a memory section to include operating segment code and a memory section to include calibration files.
